(19) United States
(12) Patent Application Publication
(10) Pub. No.: US 2008/0173105 A1
(43) Pub. Date: Jul. 24, 2008

(54) CAPACITIVE PRESSURE SENSING DEVICE

(75) Inventors: Han-Che Wang, Shenzhen City (CN); Shi-Quan Lin, Shenzhen City (CN); Kuan-Hong Hsieh, Shenzhen City (CN); Xiao-Guang Li, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/958,362

(22) Filed: Dec. 17, 2007

(30) Foreign Application Priority Data
Jan. 10, 2007 (CN) 200710200037.9

(51) Int. Cl. G01L 1/00

(52) U.S. Cl. 73/862.626

(57) ABSTRACT

A capacitive pressure sensing device includes a capacitor, a capacitive pressure transducer, a resistor, a capacitance/frequency converter and a processor. The capacitive pressure transducer includes a metal sponge, a metal layer and a capacitive sensor element. The metal sponge is sandwiched between the metal layer and the capacitive sensor element. When an external force is applied to the metal layer, the metal sponge is compressed, and reduces a distance between the metal layer and the capacitive sensor element, the capacitive pressure transducer thus produces a variable capacitance value Ct. The total capacitance value at an input terminal of the capacitance/frequency converter is contributed by the capacitor and the capacitive pressure transducer. The capacitance/frequency output a control signal according to the total capacitance value to an electronic device to trigger a corresponding function.

### BACKGROUND OF THE INVENTION

1. Field of the Invention

The present invention relates to a capacitive pressure sensing device, and particularly to a capacitive pressure sensing device which includes a capacitive pressure transducer with a metal sponge layer.

2. Description of Related Art

Most electronic devices have a plurality of switches which are used to change the working statuses of the electronic devices. Commonly, mechanical switches are operated to electrically connect two contacts of the switches with a pole, thus, forming a closed circuit for current flowing. However, mechanical switches are subject to wear and tear, and, eventual failure. Capacitive touch switches have been introduced to overcome the shortcomings encountered with mechanical switches. Capacitive touch switch are well known means for providing inputs to various devices including home appliances such as kitchen electronic devices which have touch pad devices arranged in a keyboard style array. One advantage of capacitive touch switches is that the capacitive touch switches isolate the users from system control and voltages.

The Unite States Patent Application Publication No. 20060145539, entitled “Circuit Configuration For A Capacitive Touch Switch” discloses a capacitive touch switch. This capacitive touch switch includes at least one sensor circuit with a capacitive sensor element that changes its capacitance value when touched, and an evaluation circuit that is supplied with an output signal from the sensor circuit in order to determine whether the capacitive sensor element has been actuated or not. However, the sensor circuitries in the capacitive touch switch are relatively complicated and cannot effectively eliminate electronic noise from the environment.

Therefore, what is needed to provide a capacitive pressure sensing device which can effectively eliminate electrical noise from the environment.

### SUMMARY OF INVENTION

A capacitive pressure sensing device includes a capacitor, a capacitive pressure transducer, a capacitance/frequency converter, a resistor and a processor. The capacitor is connected in parallel with the capacitive pressure transducer and defining a parallel circuit. The capacitance/frequency converter connects to the parallel circuit and generates and outputs a frequency signal having a frequency being dependent on a total capacitance of the parallel circuit formed of the capacitor and the capacitive pressure transducer. The resistor connects between an output terminal and an input terminal of the capacitance/frequency converter.

The capacitive pressure transducer includes a metal layer, a metal sponge and a capacitive sensor element. The metal sponge is sandwiched between the metal layer and the capacitive sensor element. The capacitive pressure transducer changes it's capacitance value when the metal layer is pressed. The total capacitance at the input terminal of the capacitance/frequency converter is determined, on the one hand, by the capacitor and, on the other hand, by the capacitive pressure transducer. The capacitance/frequency outputs a frequency signal according to the total capacitance at the input terminal of itself. The processor processes the frequency signal and outputs a control signal to an electronic device to trigger/signal a corresponding function.

### BRIEF DESCRIPTION OF DRAWINGS

FIG. 1 is a schematic drawing of a capacitive pressure transducer.

FIG. 2 shows a status of the capacitive pressure transducer when pressed.

FIG. 3 is a schematic diagram of a capacitive pressure sensing device including the capacitive pressure transducer of FIG. 1 in accordance with a preferred embodiment of the present invention.

FIG. 4 shows a frequency value-control signal look-up table of the capacitive pressure sensing device of FIG. 1.

### DETAILED DESCRIPTION OF THE EMBODIMENTS

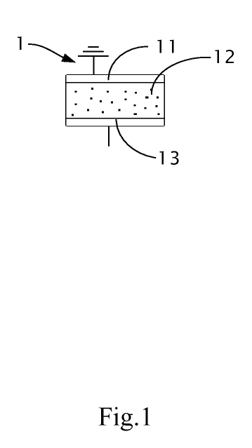

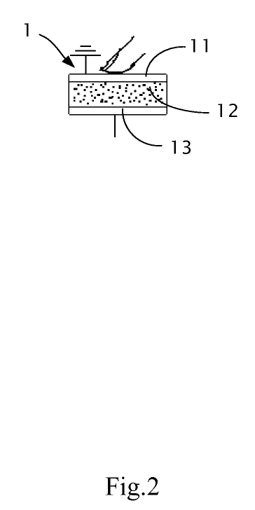

Refer to FIGS. 1 and 2. The capacitive pressure transducer 1 includes a metal layer 11, a metal sponge 12 and a capacitive sensor element 13. The metal sponge 12 is made of sponge and a plenty of granular metal material such as silver, aluminum, nickel and on the like. The metal sponge 12 is sandwiched between the metal layer 11 and the capacitive sensor element 13. The metal layer 11 is connected to ground, thus, shielding noises from the environment. The capacitive transducer 1 has a capacitance value C1 when the metal layer 11 is not pressed. As shown in the FIG. 2, when an external force is applied to the metal layer 11, the metal sponge 12 is compressed, and reduces a distance between the metal layer 11 and the capacitive sensor element 13. The capacitive pressure transducer 1 thus produces a variable capacitance value Ct.

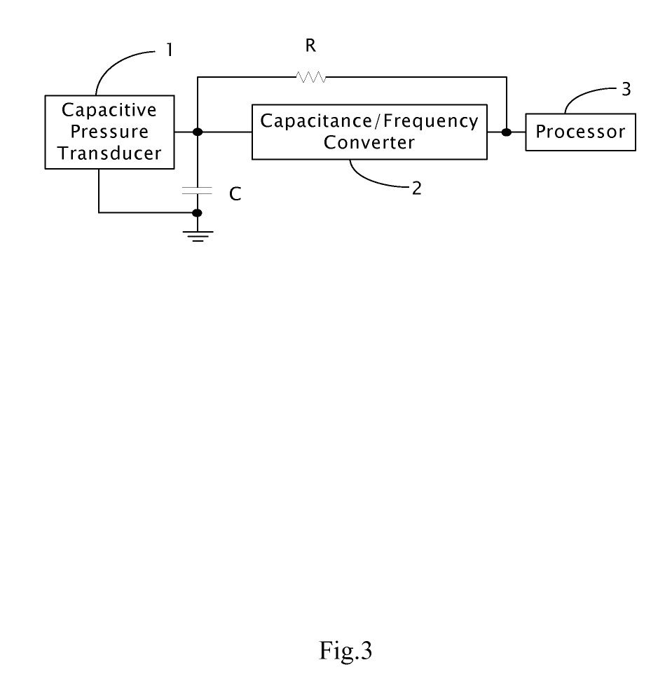

FIG. 3 is a schematic diagram of a capacitive pressure sensing device in accordance with a preferred embodiment of the present invention. A capacitor C is connected in parallel with the capacitive pressure transducer 1 to define a parallel circuit with the capacitor pressure transducer 1. A capacitance/frequency converter 2 has an input terminal connected to the parallel circuit and an output terminal connected to the parallel circuit via a resistor R. The output terminal of the capacitance/frequency converter 2 is connected to a processor 3.

The capacitance/frequency converter 2 generates and outputs a frequency signal representing a frequency reflecting a total capacitance value at the input terminal of the capacitance/frequency converter 2. If the capacitive pressure transducer 1 is not pressed, the total capacitance value at the input terminal of the capacitance/frequency converter 2 is contributed by a capacitance value C0 of the capacitor C and the capacitance value C1 of the capacitive pressure transducer 1. The capacitance/frequency converter 2 outputs a particular frequency signal representing a basic frequency f0 to the processor 3. If the capacitive pressure transducer 1 is pressed, the total capacitance at the input terminal of the capacitance/frequency converter 2 includes the capacitance value C0, the capacitance value C1 and the variable capacitance value Ct. The capacitance/frequency converter 2 outputs a frequency signal representing a frequency different from the basic frequency f0 according to the total capacitance at the input terminal.

The processor 3 receives the frequency signal outputted by the capacitance/frequency converter 2, processes the frequency signal and outputs a control signal to an electronic device (not shown) to trigger/signal a corresponding function.

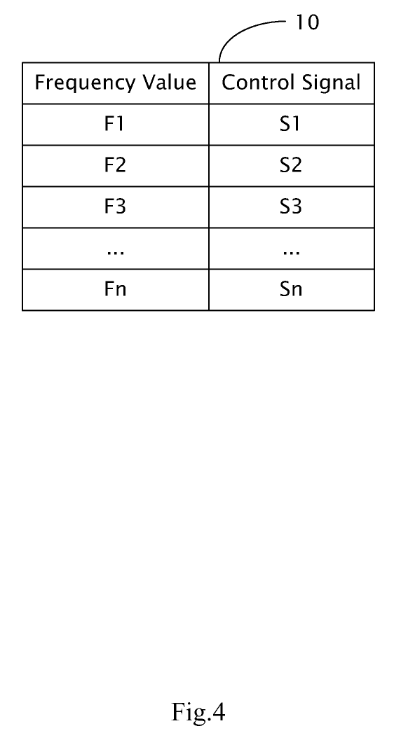

FIG. 4 shows a frequency value-control signal look-up table 10 that defines corresponding relationships between a plurality of predetermined frequency values and a plurality of control signals. The processor 3 receives the frequency signals outputted by the capacitance/frequency converter 2, and looks up the look-up table 10 to output the control signals according to the table 10 to the electronic device. For example, if the processor 3 receives the frequency signal representing a frequency f1, the processor 3 determines that the frequency f1 corresponds to a predetermined frequency value F1 recorded in the look-up table 10 and outputs a control signal S1 that corresponds to the predetermined frequency value F1 according to the look-up table 10. If the processor 3 receives the frequency signal representing a frequency f2, the processor 3 determines that the frequency f2 is coincident with a predetermined frequency value F2 recorded in the look-up table 10 and outputs a control signal S2 that corresponds to the predetermined frequency value F2 according to the look-up table 10. If the processor 3 receives the frequency signal representing a frequency f3, the processor 3 determines that the frequency f3 is coincident with a predetermined frequency value F3 recorded in the look-up table 10 and outputs a control signal S3 that corresponds to the predetermined frequency value F3 according to the look-up table 10. In the same way, if the processor receives the frequency signal representing a frequency fn, the processor 3 determines that the frequency signal is coincident with a predetermined frequency value Fn and outputs a control signal Sn that corresponds to the predetermined frequency value Fn according to the look-up table 10. The control signals S1, S2, S3, . . . Sn are outputted to the electronic device to trigger corresponding operations of the electronic device.

Although the present invention has been specifically described on the basis of a preferred embodiment and method thereof, the invention is not to be construed as being limited thereto. Various changes or modifications may be made to the embodiments without departing from the scope and spirit of the invention.

What is claimed is:

1. A capacitive pressure sensing device comprising:
a capacitive pressure transducer for changing a variable capacitance thereof when being pressed and comprising a metal layer, a capacitive element and a metal sponge sandwiched between the metal layer and the capacitive element;
a capacitor connected in parallel with the capacitive pressure transducer and defining a parallel circuit;
a capacitance/frequency converter for converting a capacitance value to a corresponding frequency signal, the capacitance/frequency converter having an input terminal and an output terminal, the input terminal being connected to the parallel circuit and for receiving the capacitance value from the parallel circuit, and the output terminal being fed back to the input via a resistor and for outputting a corresponding frequency signal;
a processor, connected to the output terminal of the capacitance/frequency converter, for processing the frequency signal and outputting a control signal to trigger a corresponding function of an electronic device.

2. The capacitive pressure sensing device as claimed in claim 1, wherein the metal layer is connected to ground to shield electrical noises from the environment of the capacitive pressure transducer.

3. The capacitive pressure sensing device as claimed in claim 1, wherein the metal sponge is compressed when an external pressure is applied to the metal layer, thus changing the variable capacitance.

4. The capacitive pressure sensing device as claimed in claim 1, further comprising a frequency value-control signal look-up table that defines corresponding relationships between a plurality of predetermined frequency values and a plurality of control signals, the processor receives a frequency signal outputted by the capacitance/frequency converter, and searches the look-up table for the corresponding control signal stored therein and the processor outputs the control signal to an electronic device to trigger a corresponding function.
